(19) United States
(12) Patent Application Publication
(10) Pub. No.: US 2008/0273481 A1
(43) Pub. Date: Nov. 6, 2008

(54) WARM START RECEIVER

(75) Inventor: Yu-Wen (Evan) Chang, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 12/113,794

(22) Filed: May 1, 2008

Related U.S. Application Data
(60) Provisional application No. 60/915,610, filed on May 2, 2007.

(51) Int. Cl. G08C 17/02; H04J 3/00

(52) U.S. Cl. 370/311; 370/345

(57) ABSTRACT

Systems, devices, and methods are described for acquiring a wireless signal including a number of time-multiplexed bursts of data. An allocated training time may be dynamically adjusted to acquire a wireless signal and capture one of the bursts of data. Also, initial filter coefficients may be established for bursts of data based on previous filter coefficients. In addition, the step size used to adapt an initial filter coefficient may also be modified to account for certain channel characteristics.

### CROSS REFERENCES

This Application claims priority from co-pending U.S. Provisional Patent Application No. 60/915,610, filed May 2, 2007, entitled “WARM START RECEIVER” (Attorney Docket No. 025950-000700US). This Application is related to U.S. patent application No. ______, filed May 1, 2008, entitled “DYNAMIC ADJUSTMENT OF TRAINING TIME FOR WIRELESS RECEIVER” (Attorney Docket No. 025950-000710US). This Application is also related to U.S. patent application Ser. No. 11/444,124, filed May 30, 2006, entitled “ADAPTIVE INTERPOLATOR FOR CHANNEL ESTIMATION,” to Long et al. These Applications are hereby incorporated by reference, as if set forth in full in this document, for all purposes.

### BACKGROUND

The present invention relates to wireless communications in general and, in particular, to the acquisition time for reception of a wireless signal.

In wireless devices, power consumption is often a concern. One technique which may be used to reduce power consumption is time-division-multiplexing (TDM). To capture the data for a specific channel, certain components of the receiver may be active for a short duration that is needed for acquisition and capturing of the actual data (often referred to as bursts), and be turned off or otherwise suspended for the rest of the time.

Certain standards, such as DVB-H standard (digital video broadcasting for handheld devices) have been developed for digital TV reception on battery-based mobile devices. A transmission channel is capable of carrying multiple TV stations. The number of TV stations in a transmission channel depends upon the type of modulation and the bandwidth of the transmission channel. The signal which is presented to the DVB-H receiver contains multiple time-sliced bursts of TV channels. The utilization of this time-division-multiplexing (TDM) scheme may reduce the overall average power consumption in a receiver. To capture the data for a specific TV channel, certain receiver components are active for a short duration that is needed for channel acquisition and capturing of the actual data. Once the data is captured, part of the receiver will be suspended for power-saving purposes.

However, it is worth pointing out that a typical receiver is not configured to simply turn on and immediately capture data. Instead, there is typically an acquisition time before each burst when the receiver is consuming power to acquire the signal before the data is captured. It may be desirable to implement novel methods and devices which allow for the reduction of acquisition time in certain circumstances.

### SUMMARY

Systems, devices, and methods are described for acquisition of a wireless signal to capturing a burst of data within a number of time-multiplexed bursts of data. In some embodiments, a training time allocation for a burst is modified when acquiring the wireless signal. This modification may be based on channel stability and other related channel characteristics. In some embodiments, initial filter coefficients may be established for subsequent bursts of data based, in part, on the previous filter coefficients. Also, the step size used to adapt an initial coefficient may also be modified to account for certain channel characteristics.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless system configured according to various embodiments of the invention.

FIG. 2 is a block diagram of a device configured according to various embodiments of the invention.

FIGS. 3A and 3B are diagrams of bursts in a broadcast signal received according to various embodiments of the invention.

FIGS. 4A, 4B, and 4C illustrate tables to direct the adjustment of training times for a receiver configured according to various embodiments of the invention.

FIG. 5 is a block diagram of a components of a device for adjusting training times configured according to various embodiments of the invention.

FIG. 6 is a flowchart illustrating a method for adjusting training times according to various embodiments of the invention.

FIG. 7 is a flowchart illustrating a method for adjusting training times for an equalizer unit according to various embodiments of the invention.

FIG. 8 is a flowchart illustrating a method for adjusting and monitoring training times for an equalizer unit according to various embodiments of the invention.

FIG. 9 is a representation of an index illustrating a range of subcarriers over time for a multicarrier signal according to various embodiments of the invention.

FIG. 10 is a block diagram of components of a device using filter coefficients from previous bursts to acquire a signal according to various embodiments of the invention.

FIG. 11 is a block diagram of components of a channel estimation unit configured according to various embodiments of the invention.

FIG. 12 is a block diagram of components of an equalizer unit configured according to various embodiments of the invention.

FIG. 13 is a flowchart illustrating a method for establishing filter coefficients for a burst based on filter coefficients from previous bursts according to various embodiments of the invention.

FIG. 14 is a flowchart illustrating a method for using previous filter coefficients and modifying step size according to various embodiments of the invention.

FIG. 15 is a flowchart illustrating a method for establishing filter coefficients for a burst based on filter coefficients from previous bursts and certain measured channel conditions according to various embodiments of the invention.

FIG. 16 is a flowchart illustrating a method for using previous filter coefficients, modifying step size, and adjusting training times according to various embodiments of the invention.

### DETAILED DESCRIPTION OF THE INVENTION

Systems, devices, and methods are described for acquiring a wireless signal including a number of time-multiplexed bursts of data. In one embodiment, techniques are described for dynamically adjusting the training time allocated to an equalizer unit for signal acquisition before capture of a burst of data. Also, techniques are described which may be used for establishing initial filter coefficients for subsequent bursts of data based in part on the filter coefficients from previous bursts. In addition, the step size used to adapt an initial filter coefficient may also be modified to account for certain channel characteristics.

The following description provides examples only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

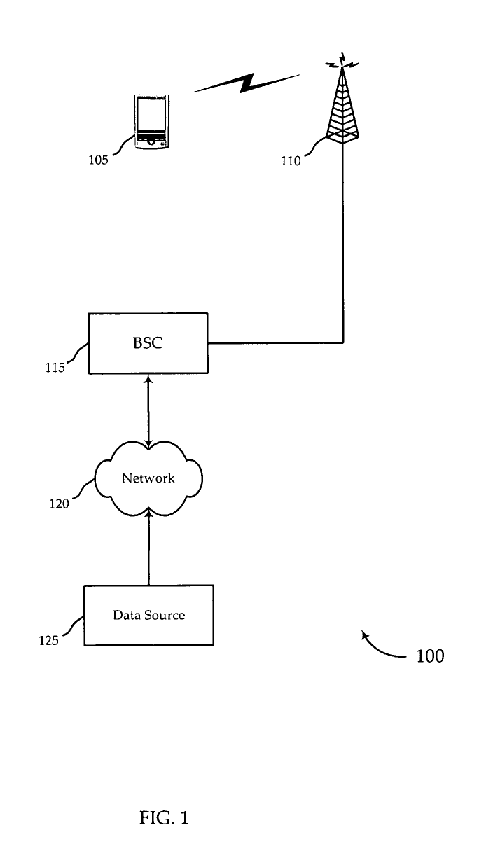

Novel systems, devices, and methods are described to efficiently acquire a wireless signal to capture a burst of data, using dynamic training time adjustments and filter coefficients computed for one or more previous bursts. Turning to FIG. 1, an example communications system 100 for implementing embodiments of the invention is illustrated. The system includes a communications device 105. The communications device 105 may be a cellular telephone, other mobile phone, personal digital assistant (PDA), portable video player, portable multimedia player, portable DVD player, laptop personal computer, a television in transportation means (including cars, buses, and trains), portable game console, digital still camera or video camcorder, or other device configured to receive wireless communications signals.

In the illustrated embodiment, the device 105 communicates with one or more base stations 110, here depicted as a cellular tower. A base station 110 may be one of a collection of base stations utilized as part of a system 100 that communicates with the device 105 using wireless signals. The device 105 may receive a wireless signal including a number of time-multiplexed bursts of data (e.g., a video broadcast signal) from the base station 110. Components of the device may be powered on or off (or otherwise suspended and reactivated) between bursts. The training time allocated for signal acquisition of a particular burst may be dynamically modified, and the initial filter coefficients used to acquire a burst may be established based on previous coefficients. These novel techniques related to the efficient acquisition of a time sliced wireless signal will be described in detail below.

The base station 110 is in communication with a Base Station Controller (BSC) 115 that routes the communication signals between the network 120 and the base station 110. In other embodiments, other types of infrastructure network devices or sets of devices (e.g., servers or other computers) may also serve as an interface between a network 120 and the base station 110. For example, a BSC 115 may communicate with a Mobile Switching Center (MSC) that can be configured to operate as an interface between the device 105 and a Public Switched Telephone Network (PSTN).

The network 120 of the illustrated embodiment may be any type of network, and may include, for example, the Internet, an IP network, an intranet, a wide-area network (WAN), a local-area network (LAN), a virtual private network (VPN), the Public Switched Telephone Network (PSTN), or any other type of network supporting data communication between any devices described herein. A network 120 may include both wired and wireless connections, including optical links. The system 100 also includes a data source 125, which may be a server or other computer configured to transmit data (video, audio, or other data) to the communications device 105 via the network 120.

It is worth noting that aspects of the present invention may be applied to a variety of devices (such as communications device 105) generally and, more specifically, may be applied to mobile digital television (MDTV) devices. Aspects of the present invention may be applied to digital video broadcast standards that are either in effect or are at various stages of development. These may include the European standard DVB-H, the Japanese standard ISDB-T, the Korean standards digital audio broadcasting (DAB)-based Terrestrial-DMB and Satellite-DMB, the Chinese standards DTV-M, Terrestrial-Mobile Multimedia Broadcasting (T-MMB), Satellite and terrestrial interaction multimedia (STiMi), and the MediaFLO format proposed by Qualcomm Inc. While certain embodiments of the present invention are described in the context of the DVB-H standard, it may also be implemented in any of the above or future standards, and as such is not limited to any one particular standard.

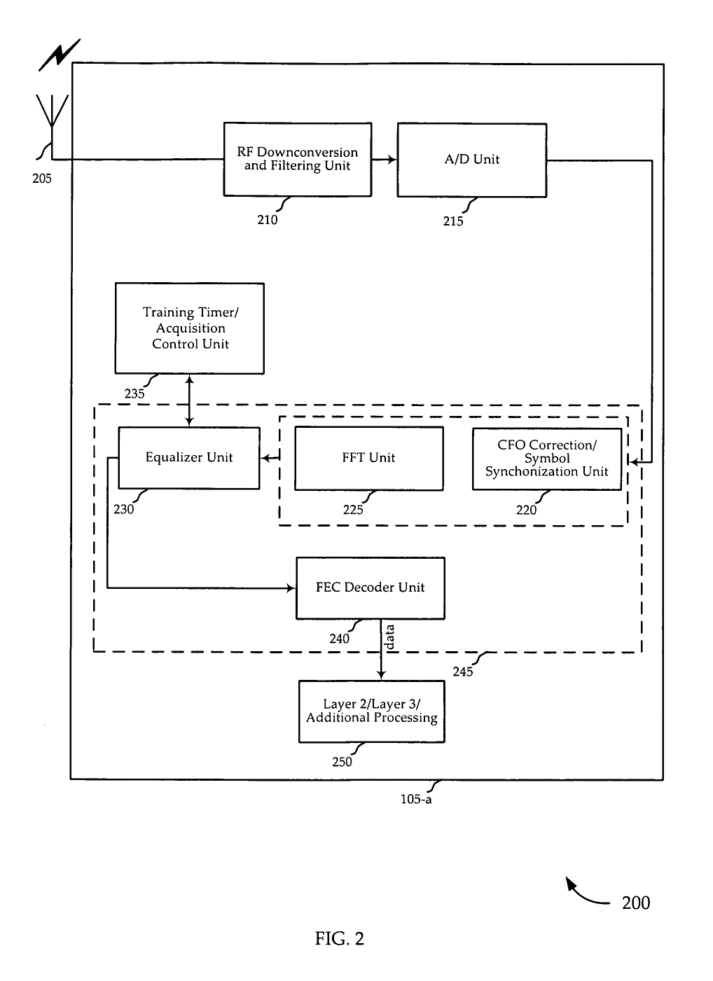

Referring to FIG. 2, a block diagram 200 of an example device 105-a is shown which illustrates various embodiments of the invention. The device 105-a may be the communications device 105 of FIG. 1. In the embodiments described herein, assume an orthogonal frequency division multiplexing (OFDM) system is implemented, while realizing that the principles described are applicable to a multicarrier signal in a range of both wireless and wireline systems.

The device 105-a may be made up of a number of components, which may include: an RF down-conversion and filtering unit 210, A/D unit 215, CFO correction/symbol synchronization unit 220, FFT unit 225, equalizer unit 230, training timer/acquisition control unit 235, FEC decoder unit 240, and additional layer 2/layer 3 processing unit 250. These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application specific processors.

In one embodiment, the radio frequency signal is received via an antenna 205. The desired signal is selected and down-converted and filtered through the RF down-conversion and filtering unit 210. The output of that unit 210 is the analog baseband (or passband at much lower frequency than the original radio frequency) signal, which is converted into a digital signal by the A/D unit 215. At the CFO correction/symbol synchronization unit 220, the frequency offset of the signal is corrected, the signal is grouped into symbols with a symbol boundary properly identified, and the guard periods (typically cyclic prefix) removed. The CFO and symbol timing errors may be estimated and corrected before and/or after the FFT is performed. Regardless, the signal is provided to FFT unit 225, where it is transformed to the frequency domain.

The signal is then processed by the equalizer unit 230. In one embodiment, therefore, the equalizer unit 230 processes the signal in the frequency domain. With orthogonality, the subcarriers do not interfere with each other, so a frequency-domain equalizer can be implemented separately for each subcarrier (sometimes also called bin or carrier). Since the symbols are separated by some guard time period (cyclic prefix), the inter-symbol-interference (ISI) may be avoided. Hence, such an equalization simply becomes a one-tap complex scaling. This complex tap coefficient can be determined adaptively through training, and may be updated during data transmission. The equalizer unit 230 may include the functionality described in commonly assigned U.S. patent application Ser. No. 11/444,124, filed May 30, 2006, entitled “ADAPTIVE INTERPOLATOR FOR CHANNEL ESTIMATION,” to Long et al, which is hereby incorporated by reference in its entirety for all purposes.

The device includes a training timer/acquisition control unit 235 to dynamically adjust the training time for the equalizer unit 230. The training timer/acquisition control unit 235 may control any combination of the receiver components 245 (e.g., only the equalizer unit 230, a staggered combination of components, or some or all in unison) to suspend and then activate such components between bursts. The suspension may be a temporary deactivation, a powering down, a shut off, or a lower power mode. The activation may be a temporary activation, or a powering up from an off mode or a low power mode, for example. Thus, in one embodiment, the training timer/acquisition control unit 235 may adjust the time allocated to pre-burst processing (i.e., the training time) by the equalizer unit 230. By reducing the time allocated for processing by the equalizer unit 230, the time allocated for signal acquisition may be reduced concurrently, and the receiver components 245 (or any subcombination thereof) may be activated for a reduced period of time for signal acquisition. Thus, the training time adjustments may be for any selection of components, for example, the RF down-conversion and filtering unit 210, A/D unit 215, CFO correction/symbol synchronization unit 220, FFT unit 225, equalizer unit 230, or any combination thereof. The training timer/acquisition control unit 235 may be a CPU which remains active while one or more of the receiver components 245 are suspended between bursts. However, in some embodiments, the training timer/acquisition control unit 235 may be suspended for certain periods (e.g., between bursts) as well. The training timer/acquisition control unit 235 may reduce the time allocated to the equalizer unit 230 based, for example, on one or more of the following: SNR, time between bursts, previous training times, trend or variability of previous training times, and other factors as well.

The training timer/acquisition control unit 235 may measure a variety of metrics, or may receive such measurements from other components on or off the device 105-a. For example, this unit 235 may measure, or otherwise receive a measurement of, the training time from the equalizer unit 230 on a previous burst, or set of bursts. It may measure or receive various measures of the processing time for one or more of the receiver components 245 in one or more of the previous bursts. The training timer/acquisition control unit 235 may measure or receive various measures of signal strength, such as SNR or BER. The unit 235 may also measure or receive measurements of time between previous bursts, and of filter coefficients (as set or adapted) from a previous burst or set of bursts. The training timer/acquisition control unit 235 may measure or receive measurements related to velocity of the device 105-a, location (e.g., via GPS) of the device 105-a, or orientation of the device. The training timer/acquisition control unit 235 may store any measurements made or received.

The training timer/acquisition control unit 235 may access such stored measurements, and dynamically adjust the training time allocated to the equalizer unit 230 on a per burst basis, based in part on any of the measurements. For example, if the training time needed for the previous burst was a certain threshold amount below the current training time allocation, the training time allocation could be reduced. Moreover, instead of simply relying on the training time of the previous burst, the training timer/acquisition control unit 235 could reduce the training time based on an average over the recent x number of bursts; more recent bursts could be weighted more heavily. The training time may also be adjusted downward more slowly, with incremental changes that represent only a percentage of the difference between training time needed for the previous burst and the current training time allocation.

The training timer/acquisition control unit 235 may also determine the adjustment based on additional factors. By way of example, if the SNR suddenly becomes markedly lower, and the velocity and orientation change, the training timer/acquisition control unit 235 may extend the training length substantially. If the necessary training time varies substantially between past bursts, the training timer/acquisition control unit 235 may adjust the training time downward more slowly than with a more stable environment.

The training timer/acquisition control unit 235 also may utilize the filter coefficients computed for previous bursts to determine initial filter coefficients to use in acquiring the signal to capture a next burst. The training timer/acquisition control unit 235 may identify the particular values for the coefficients (e.g., averaging interpolation filter coefficients from previous bursts). Depending upon the implementation, the previous coefficients may be real or complex. Initial coefficients may be set based on incremental changes that represent only a fraction of the difference between the filter coefficients for a previous burst and the worst case coefficients.

The training timer/acquisition control unit 235 may also set initial filter coefficients, or determine the adjustment to updated coefficients, based in part on variability of filter coefficients within or across previous bursts, SNR or other signal strength metrics, past or future time between bursts, velocity of the device 105-a, location (e.g., via GPS) of the device 105-a, or orientation of the device 105-a. Those skilled in the art will recognize the many variations available. Thus, once the initial coefficients are set, the step size used to adapt such coefficients may be modified. By way of example, the initial coefficients may be adapted more slowly or more rapidly depending on the stability of previous coefficients.

The equalized signal may be forwarded to a FEC decoder unit 240, which may decode the signal and output a steam of data. This data stream may be forwarded to a layer 2/layer 3/additional processing unit 250 for further processing. It is worth noting that in one embodiment, the CFO correction/symbol synchronization unit 220, FFT unit 225, equalizer unit 230, training timer/acquisition control unit 235, and FEC decoder unit 240 are implemented in a single PHY chip, receiving a digitized version of the wireless signal through an input port. It is also worth noting that in another embodiment, the RF down-conversion and filtering unit 210, A/D unit 215, CFO correction/symbol synchronization unit 220, FFT unit 225, equalizer unit 230, training timer/acquisition control unit 235, and FEC decoder unit 240 are implemented in a single chip with RF and PHY functionality, receiving the wireless signal through an input port.

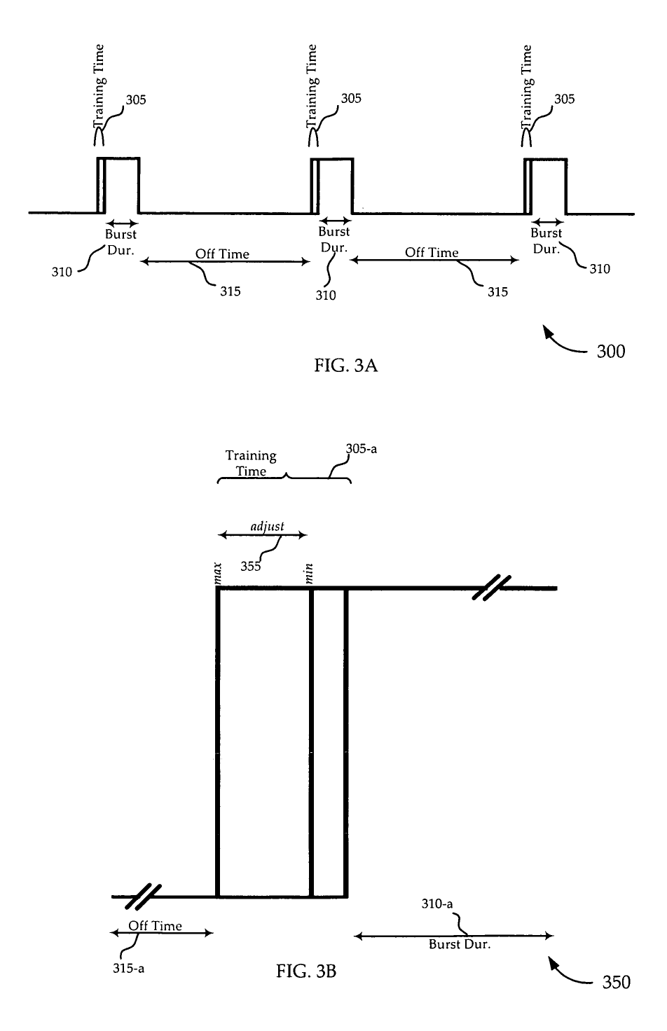

Turning to FIG. 3A, a diagram is shown illustrating a time sliced signal 300 including a series of time-multiplexed bursts of data according to various embodiments of the invention. This may be a wireless video broadcast signal (e.g., a DVB-H signal) received and processed by the device 105 of FIG. 1 or 2.

The time sliced signal 300 includes a series of bursts 310 of data for a particular channel (sometimes referred to as an elementary stream). Between the bursts, data for that channel is not transmitted, allowing other channels to use the time between bursts. Thus, a receiver (or certain components thereof) may be suspended during some of this off-time 315, then reactivated to capture a burst. This structure of data bursts 310, when used with mobile devices, may allow a receiver to stay active for only a fraction of time (e.g., only enough time to capture the burst). The illustrated diagram is shown for purposes of example only, as the duty cycle may be, for example, ≦1%, ≦2%, ≦5%, ≦10%, or ≦20%.

The diagram of the signal also illustrates a training time 305, which represents a period of time used by (or allocated to) the receiver to acquire the received signal before the data is captured. By modifying or adapting this training time 305 to the channel conditions and/or particular characteristics of the signal, a receiver may in certain circumstances lessen the unnecessary use acquisition time, thereby reducing power consumption in a mobile device.

Turning to FIG. 3B, a magnified view of an example of training time 305-a adjustment for acquisition of a signal 350 is shown. This signal 350 may be the signal 300 of FIG. 3A. The training time 305-a illustration of FIG. 3B shows how training time may have an adjustable range 355 between a minimum and maximum, based on any combination of factors. In one embodiment, the decision whether to adjust training time 305 may be made during off-time 315-a after the previous burst has been processed. In such an embodiment, a decision on the amount of adjustment may also be made during off-time 315-a. In other embodiments, the decisions whether to adjust training time 305-a and the amount of adjustment may be made during the immediately previous burst, or before. There are, therefore, a number of options regarding the timing of when decisions to adjust training time, and the amount of adjustment, are made.

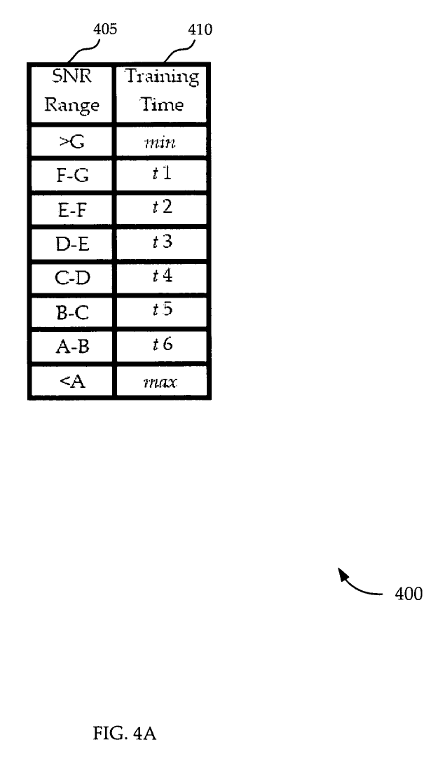

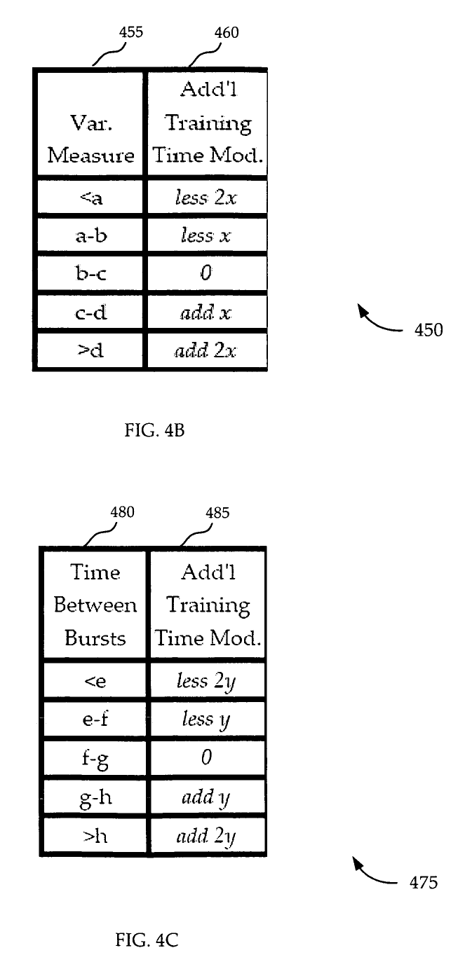

Referring next to FIG. 4A, an example of a training time table 400 is illustrated that may be used to set or adjust training time. This type of training time table 400 may, for example, be used by training timer/acquisition control unit 235 of FIG. 2 to set or modify the training time to be used before capture of a burst of data. The table 400 contains a column 405 listing a number of SNR ranges. Each training time entry 410 corresponds to a set of ranges 405. Thus, using an SNR measurement attributed to a signal (e.g., signal 300 of FIG. 3A), an entry for a range 405 encompassing the SNR may be identified, and the corresponding training time 410 may be selected thereby. For example, if a signal has an SNR that changes from range D-E to E-F, the training time may be reduced dynamically from t3 to t2. This illustrates how different thresholds (in this case, across ranges of SNR measurements) may be used to trigger and set adjustment parameters

In other embodiments, other metrics and indicators may be used in addition to or in place of SNR, and may also use similarly structured thresholds. For example, time between bursts, previous training times, trends or variability of previous training times, previous filter coefficients, trend or variability of previous filter coefficients, velocity, or location may be used as the primary or as secondary factors. It is also worth noting that a number of other data structures may also be used to relate channel or signal characteristics (or other signal processing metrics) to training times. The margin and rate of adaptation may be dynamically modified as well depending, for example, on a particular application or device being used.

Referring next to FIG. 4B, an example of a training time table 450 is illustrated that may be used to modify a training time determination (e.g., as set by the table 400 of FIG. 4A). This type of training time table 450 may, for example, be used by training timer/acquisition control unit 235 of FIG. 2 to dynamically modify a training time setting to be used before capture of a burst of data. The table 450 contains a column 455 listing ranges of training time variability (e.g., illustrating the amount and rate of training time changes) for a series of previous bursts. Each training time modification entry 460 corresponds to a range of variability measures. Thus, using a measurement 455 identifying the variability of training time needed over previous bursts (e.g., training time 305 for bursts 310 of the signal 300 of FIG. 3A), an entry for an additional training time modification 460 may be selected. Thus, as training times stabilize, the amount of training time allocation may be further reduced. For example, if a training time used becomes less variable (e.g., changing from a−b to <a), a training time may be further reduced (from less x to less 2x).

Referring next to FIG. 4C, an example of a training time table 475 is illustrated that may be used to modify a training time determination (e.g., as set by the table 400 of FIG. 4A). This type of training time table 475 may, for example, be used by training timer/acquisition control unit 235 of FIG. 2 to dynamically modify a training time setting to be used before capture of a burst of data. The table 475 contains a column 480 listing a number of time ranges indicative of time between bursts. Each training time modification entry 485 corresponds to a set of time ranges between bursts. Thus, using an estimation or other determination of the time between bursts (e.g., off-time 315 between bursts 310 of signal 300 of FIG. 3A), an entry for an additional training time modification 485 may be selected. In one embodiment, as time between bursts increases, the amount of training time allocation may be increased. For example, a large gap between bursts may reduce the likelihood that previous bursts will provide accurate information for later bursts. Again, it is worth noting that a number of other data structures or processing algorithms may also be used to relate channel or signal characteristics (or other signal processing metrics) to training times.

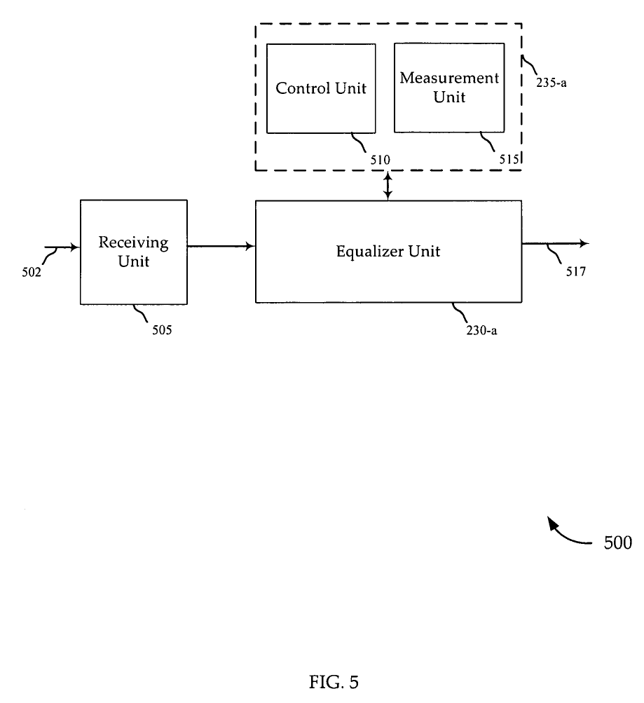

Turning to FIG. 5, a block diagram is shown illustrating an example configuration 500 of an equalizer unit 230-a and a training timer/acquisition control unit 235-a that may dynamically adjust training times in response to changing signal, channel, or signal processing characteristics, according to various embodiments of the invention. These units 230-a and 235-a of FIG. 5 may be the equalizer unit 230 and a training timer/acquisition control unit 235 of FIG. 2, implemented in the communications device 105 of FIG. 1. However, some or all of the functionality of these units 230-a and 235-a may be implemented in other devices.

The illustrated embodiment includes a receiving unit 505, equalizer unit 230-a and training timer/acquisition control unit 235-a (including a control unit 510 and measurement unit 515). These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiving unit 505 may, for example, be the RF downconversion and filtering unit 210, FFT unit 225, or input port of the equalizer unit 230 of FIG. 2. Thus, the receiving unit 505 may be any component configured to receive a wireless signal 502 with time-multiplexed bursts of data (e.g., bursts 310 of FIG. 3A). The received signal may be in analog form, or a digitized representation of the signal including a series of real or complex samples.

The equalizer unit 230-a may be configured to power on to process a subset of plurality of time-multiplexed bursts of data, and reduce power consumption to enter a power saving mode between the subset of bursts according to a second control signal. In various embodiments, there are a variety of suspension and activation techniques that may be used to power off or down between bursts.

The control unit 510 is in communication with the equalizer unit 230-a, and may be configured to dynamically adjust a training time allocation for the equalizer unit 230-a to acquire the wireless signal before capturing a burst. Thus, the control unit 510 may make the determination of whether to modify the training time allocation, and determine the amount of the adjustments. One or both of these determinations may, for example, be made while the previous burst is still being processed, or after the previous burst is processed and the equalizer unit 230-a is suspended. The control unit 510 may also send various control signals to suspend and activate the equalizer unit 230-a (or other components of the device 105-a of FIG. 2) between bursts according to the dynamic adjustment determinations.

In one embodiment, the training timer/acquisition control unit 235-a includes a measurement unit 515. The measurement unit 515 may measure a variety of metrics, or may receive such measurements from other components on or off the device 105. For example, the measurement unit 515 may measure, or otherwise receive a measurement of, the training time required for the equalizer unit 230-a on a previous burst, or set of bursts. The measurement unit 515 may measure or receive various measures of the processing time for one or more of the receiver components 245 of FIG. 2 in the previous one or more bursts. The measurement unit 515 may measure or receive various measures of signal strength, such as SNR or BER, for a previous burst or series of bursts. The measurement unit 515 may also estimate, measure, or receive measurements of time between previous bursts. The measurement unit 515 may measure or receive measurements related to velocity of the device 105 (e.g., for a previous burst, or averaged over a series of bursts), location (e.g., via GPS) of the device 105, or orientation or position of the device. The measurement unit 515 may store any measurements made or received in memory (which may be in the training timer/acquisition control unit 235-a, or shared with other components of a device 105).

The control unit 510 may query the memory to thereby access the measurements. The control unit 510 may dynamically adjust the training time allocated to the equalizer unit 230-a on a per burst basis (e.g., both making a determination to adjust the training time and then setting the training time adjustment after the equalizer unit 230-a is suspended after a previous burst). The control unit 510 may use measurements from the immediately preceding burst to adjust the training time for a next burst to be captured. The control unit 510 may, therefore, decide to make a dynamic adjustment and determine the amount of adjustment after the equalizer unit 230-a is suspended after processing the previous burst. These decisions may also be made during or before the previous burst.

These control unit 510 adjustment decisions may be based on any combination of the measurements. For example, when the training time needed for the previous burst is below the current training time allocation, the training time allocation could be reduced. Also, as this difference decreases, the training time could be extended. Moreover, instead of simply relying on the training time of the previous burst, the control unit 510 could reduce the training time based on an average over recent window of bursts, and more recent bursts could be weighted more heavily. The training time may also be adjusted downward more slowly, with incremental changes that represent only a percentage of the difference between training time needed for the previous burst and the current training time allocation. The control unit 510 may also measure the variability of training times over a series of bursts (e.g., including the rate and amount of change), and use this variability measure to determine the amount of change. For example, in stable environments, the dynamic training adjustments may be more pronounced than in unstable environments.

The control unit 510 may query the memory to access the measurements on SNR or other signal quality metrics (e.g., relying on a measurement for the previous burst, or an average over a period of time). As the SNR increases, the training time needed to acquire the signal may decrease. The control unit 510 may process the SNR measurement, and the measurement may trigger the adjustment, and also be used by the control unit 510 to identify the amount of adjustments.

The control unit 510 may query the memory to access the measurements on past or future time between bursts. This information on time between bursts may be used by the control unit 510 to identify the amount of adjustment. As the time between future bursts increases, the amount of adjustment may be decreased. Also, the measurements may be given different weights as the time between past bursts varies.

The control unit 510 may query the memory to access the measurements on velocity, location, or orientation of a device 105. The control unit 510 may process one or more of these measurements, which may trigger the adjustment. Such measurements may be used by the control unit 510 to identify the amount of adjustments. By way of example, if the measurements indicate that the device is not moving (e.g., no velocity or orientation change), and is in a suburban environment, the control unit 510 may be configured to adjust the training time more quickly (which may entail making a larger adjustment). An increase in velocity could trigger an adjustment extending training time.

The control unit 510 may also query the memory to access filter coefficients (e.g., initial coefficients or as updated) from one, or more, previous bursts. The control unit 510 may process such filter coefficients, weighting recent filter coefficients from recent bursts more heavily. These filter coefficients may trigger the adjustment, and also be used by the control unit 510 to identify the amount of adjustments. For example, when filter coefficients indicate improving channel characteristics, the training time allocation could be decreased. Similarly, as filter coefficients indicate worsening channel characteristics, the training time could be extended. When filter coefficients indicate a worsening channel, the training time may also be adjusted downward more slowly, with incremental changes that represent only a percentage of the difference between training time needed for the previous burst and the current training time allocation. The control unit 510 may also measure the variability of filter coefficients over a series of bursts (e.g., including the rate and amount of change), and use this variability measure to determine the amount or rate of change. For example, in stable environments, the dynamic training adjustments may be more pronounced than in unstable environments. Thus, the control unit 510 may iteratively adjust the training time at different rates based on channel characteristics.

Once the dynamically adjusted training time is set, the equalizer unit 230-a may use initial filter coefficients based on the filter coefficients from one or more previous bursts. When identified properly, use of previously computed filter coefficients to determine initial filter coefficients may reduce training times required to acquire the signal, and thus allow training time allocations to be further adjusted downward. In addition, the step size used in adapting the initial filter coefficient may be set or changed based on the stability of certain channel characteristics. These aspects will be discussed in more detail below.

The equalizer unit 230-a may, therefore, process the received signal as described above, and generate an equalized signal 517 to be forwarded. It is worth noting that the metrics used above are merely examples, and implementations may in certain instances utilize only a subset of these metrics in adjusting training times.

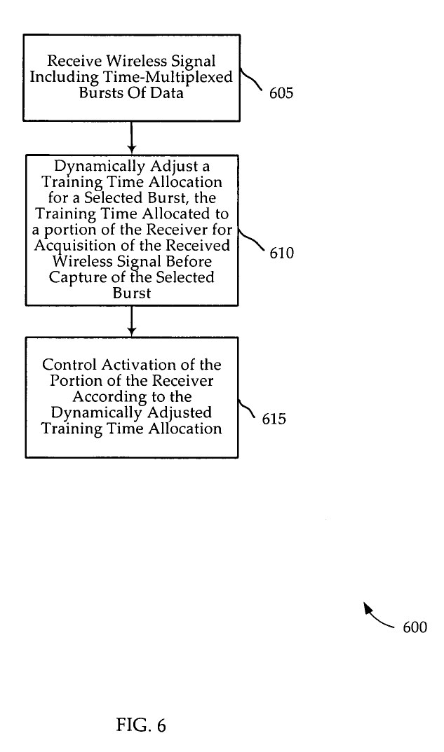

FIG. 6 is a flowchart illustrating a method 600 of dynamically adjusting the training time allocated to acquire a wireless signal before capturing a burst of a series of time-multiplexed bursts of data according to various embodiments of the invention. The method 600 may, for example, be performed in whole or in part on the mobile communications device 105 of FIG. 1 or 2 or, more specifically, using a combination of the equalizer unit 230 and training timer/acquisition control unit 235 of FIG. 2 or 5.

At block 605, a wireless signal, including time-multiplexed bursts of data, is received. At block 610, a training time allocation is dynamically adjusted for a selected burst, the training time allocated to a portion of the receiver for acquisition of the received wireless signal before capture of the selected burst. At block 615, the applicable portion of the receiver is activated according to the dynamically adjusted training time allocation.

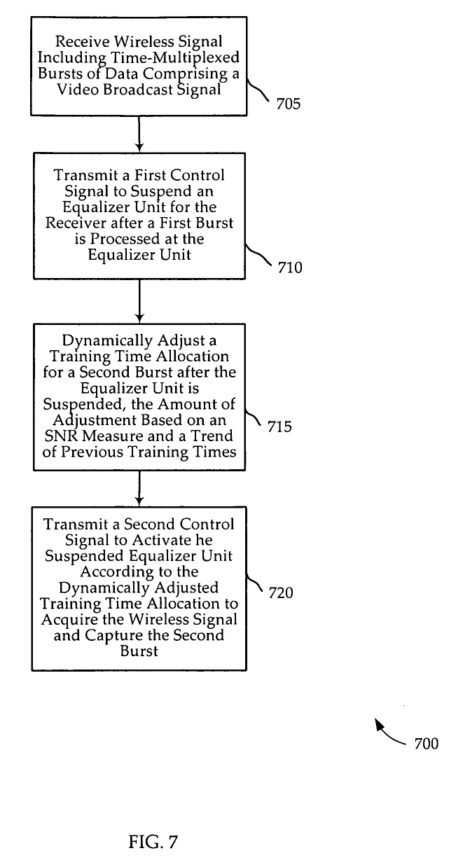

FIG. 7 is a flowchart illustrating a method for adjusting training times for an equalizer unit according to various embodiments of the invention. As above, the method 700 may, for example, be performed in whole or in part on the mobile communications device 105 of FIG. 1 or 2 or, more specifically, using a combination of the equalizer unit 230 and training timer/acquisition control unit 235 of FIG. 2 or 5.

At block 705, a wireless signal, including time-multiplexed bursts of data comprising a video broadcast signal, is received. At block 710, a first control signal is transmitted to suspend an equalizer unit after a first burst is processed at the equalizer unit. At block 715, a training time allocation is dynamically adjusted for a second burst after the equalizer unit is suspended, the amount of adjustment based on an SNR measure and a trend of previous training times. At block 720, a second control signal is transmitted to activate the suspended equalizer unit according to the dynamically adjusted training time allocation.

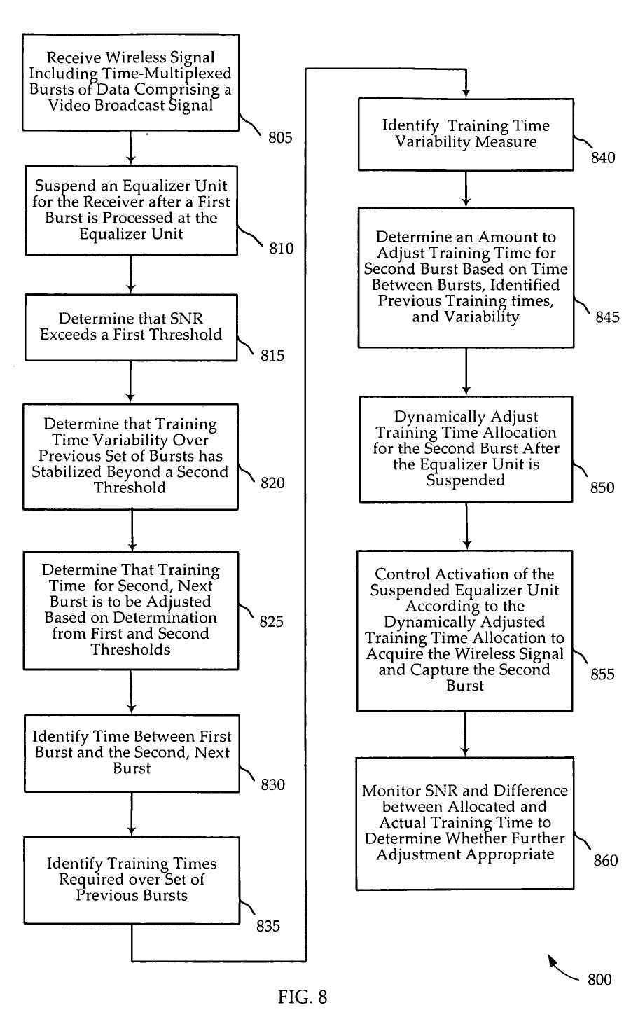

FIG. 8 is a flowchart illustrating a method for adjusting and monitoring training times for an equalizer unit according to various embodiments of the invention. As above, the method 800 may, for example, be performed in whole or in part on the mobile communications device 105 of FIG. 1 or 2 or, more specifically, using a combination of the equalizer unit 230 and training timer/acquisition control unit 235 of FIG. 2 or 5.

At block 805, a wireless signal, including time-multiplexed bursts of data comprising a video broadcast signal, is received. At block 810, an equalizer unit for the receiver is suspended after a first burst is processed at the equalizer unit. At block 815, it is determined that an SNR exceeds a first threshold. At block 820, it is determined that training time variability over a previous set of bursts has stabilized beyond a second threshold. At block 825, it is determined that training time for a second, next burst is to be adjusted based on the determination from the first and second thresholds.

At block 830, an estimated time between the first burst and the second, next burst is identified. At block 835, training times required over a set of previous bursts are identified. At block 840, a training time variability measure is identified. At block 845, an amount to adjust training time for the second burst is determined based on the time between bursts, the identified previous training times, and the variability.

At block 850, the training time allocation for the second burst is dynamically adjusted after the equalizer unit is suspended. At block 855, activation of the suspended equalizer unit is controlled according to the dynamically adjusted training time allocation. At block 860, SNR and the difference between allocated and actual training time is monitored to determine whether further adjustment is appropriate.

Returning briefly to FIG. 5, recall that device 105-a is configured with an equalizer unit 230-a that may utilize filter coefficients from a previous burst upon activation to acquire a signal and capture a next burst. This process may be done with, or without, the dynamic adjustment of training times described above. The control unit 510 may identify the particular values for initial coefficients upon activation of the equalizer unit 230-a. By way of example, the interpolation filter coefficient values from a previous burst may be used. Depending upon the implementation, the previous coefficients may be real or complex. Moreover, past coefficients updated over the time-domain or frequency-domain, or a combination thereof, may be used. The control unit 510 may use the coefficients based on an average within a burst or over a recent number of previous bursts; more recent computations may be weighted more heavily. In one embodiment, the coefficients may be adjusted slowly or more rapidly from a standard set of initial coefficients in which a worst case channel is assumed. For example, coefficients may be set, and then adapted at different rates based on channel characteristics. In one embodiment, initial coefficients may be set at only a fraction of the difference between the coefficients for a previous burst or bursts and the worst case coefficients.

To further explain certain embodiments, again consider the reception of an OFDM signal (e.g., OFDM signal transmitted according to DVB-H standard), while noting that aspects of the embodiments may be implemented in any of a number of transmission standards, and as such is not limited to any one particular standard.

As noted above, the equalizer unit 230-a may be a frequency-domain equalizer (FEQ) implemented separately for each subcarrier. Complex tap coefficients can be determined adaptively through training, and thus may be updated during data transmission. By using filter coefficients derived from previous bursts to identify initial coefficients for a next burst, knowledge of the channel may be leveraged across bursts. This may result in fewer calculations to adaptively train coefficients at the start of each burst, and thus may require less training time. These filter coefficients may be set, and adapted, through various channel estimation techniques. Suppose at sub-carrier k and time nT, where T is the symbol interval, the signal transmitted from the transmitter is X(n,k), the channel transfer function is H(n,k), and the received signal at the receiver is Y(n,k), then Y(n,k)=X(n,k)H(n,k). If H(n,k) is known, filter coefficients may be set to 1/H(n,k), then Y(n,k)/H(n,k)=X(n,k). The channel transfer function is not known to the receiver. Thus, the equalizer unit 230-a may attempt to estimate H(n,k) for each subcarrier.

If X(n,k) and Y(n,k) are known, H(n,k)=Y(n,k)/X(n,k) can be estimated. Y(n,k) is available at the receiver. In order for the receiver to know X(n,k), typically, some predefined training signals are transmitted from the transmitter at some particular times/frequencies. For stationary or slow-varying channels, those training signals may be transmitted in the initial training phase before data transmission starts. Afterwards, X(n,k) is typically obtained through receiver decision or some occasionally transmitted reference signals. For fast-varying channels typical in mobile communications, the reference signals may be transmitted from the transmitter at numerous pre-defined times and frequencies within a single burst so that the receiver can estimate the channel transfer function frequently enough to track the channel variations. The transmission of the reference signal will consume some channel bandwidth, resulting in the reduction of the data transmission rate. The reference signals may be transmitted in a small percentage of time/frequency. For each new burst, a receiver may take advantage of those snap-shot training signals to compute the channel transfer function at those particular time/frequency snap-shots, and then estimate the channel transfer functions at all other times/frequencies using previously computed filter coefficients in conjunction with the known channel transfer functions. After obtaining the channel transfer function estimates H(n,k) for all the time/frequencies, 1/H(n,k) is used as the filter coefficient for k-th sub-carrier at time nT. Finally, the estimate of the transmitted signal is obtained as Y(n,k)/H(n,k).

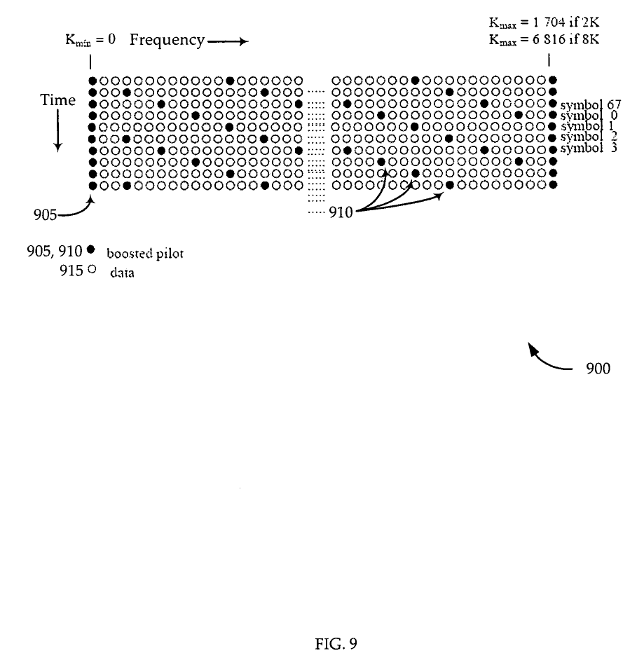

A typical example can be seen in DVB-T, which uses OFDM modulation with 2k or 8k subcarriers. For the 2k-mode, 45 subcarriers are used as continual pilot tones. For the 8k-mode, 177 subcarriers are used as continual pilot tones. DVB-H specification is based on DVB-T, but tailored to the mobile/handheld applications. In DVB-H, an additional 4k-mode is defined. FIG. 9 shows the pilot insertion pattern 900 in DVB-T and DVB-H. FIG. 9 will be used to define terminology used herein. In FIG. 9, the horizontal dimension represents frequency domain and the vertical dimension represents time domain. Each black circle 905, 910 will be referred to as a pilot cell and each white circle 915 will be referred to as a data cell. Each row in FIG. 9 corresponds to a distinct symbol, and each column will be referred to as a tone. A column with only pilot cells (such as the far left and far right columns) will be referred to as a continual pilot tone 905, and a row with only pilot cells will be referred to as a continual pilot symbol. Each column or row with both pilot cells 910 and data cells 915 will be referred to as a scattered pilot tone or symbol. Note that in FIG. 9, there is no continual pilot symbol, nor non-pilot symbol, but in other embodiments there may be.

In FIG. 9, in every symbol, some subcarriers are used as scattered pilot cells. The scattered pilot cells are 12 carriers apart in frequency and the carrier positions are shifted by three every symbol. As a result, the scattered pilot cells are 4 symbols apart in time. At the rest of times/frequencies except the continual pilot tones, the data signals are transmitted. Since the pilot signals are known to the receiver, they can be used by the receiver to calculate the channel transfer functions at those particular times/frequencies. They may then be used with initial filter coefficients calculated from the filter coefficients from a previous burst to calculate (interpolate) the estimated channel transfer function H(n,k) at all other times/frequencies which are used by the receiver to compensate the channel distortion and detect the data properly. The interpolation may be two-dimensional in time and frequency.

The two-dimensional interpolation may be implemented with two separate one-dimensional interpolations. Filter coefficients from a previous burst may be used with channel transfer function information from the pilot cells to interpolate in time domain at all the scattered pilot tones. Since at a particular scattered pilot tone ki, the pilot cell is sent 4 symbols apart in time, X(n+4m,ki), m=0,±1, ±2 . . . From X(n+4m,ki) and Y(n+4m,ki), H(n+4m,ki) is obtained, then H(n+4m+1,ki), H(n+4m+2,ki) and H(n+4m+3,ki) need to be estimated. This is time domain interpolation, and the initial filter coefficients used for this interpolation may be based, perhaps only in part, on filter coefficients from previous bursts. In the frequency domain, the scattered pilot tones are 3 tones apart. The frequency domain interpolation at time n uses H(n,k+3j), j=0, ±1, ±2 . . . to estimate H(n,k+3j+1), H(n,k+3j+2) at non-pilot carriers. This is frequency domain interpolation, and the initial filter coefficients used for this interpolation may be based, perhaps only in part, on filter coefficients from previous bursts.

Either of the interpolation operations can be implemented with a finite impulse response (FIR) filter. Such a FIR filter may simply be an interpolation filter that is a low-pass filter. The bandwidth of the low-pass filter may be adapted to cover the worst-case channel variation. For DVB-T/DVB-H, the time-domain interpolation filter may be a ¼-passband low-pass filter whose passband covers the worst-case Doppler frequency; and the frequency domain interpolation filter may be a ⅓-passband low-pass filter whose passband covers the worst-case multi-path delay dispersions. The interpolation filters may use real or complex coefficients.

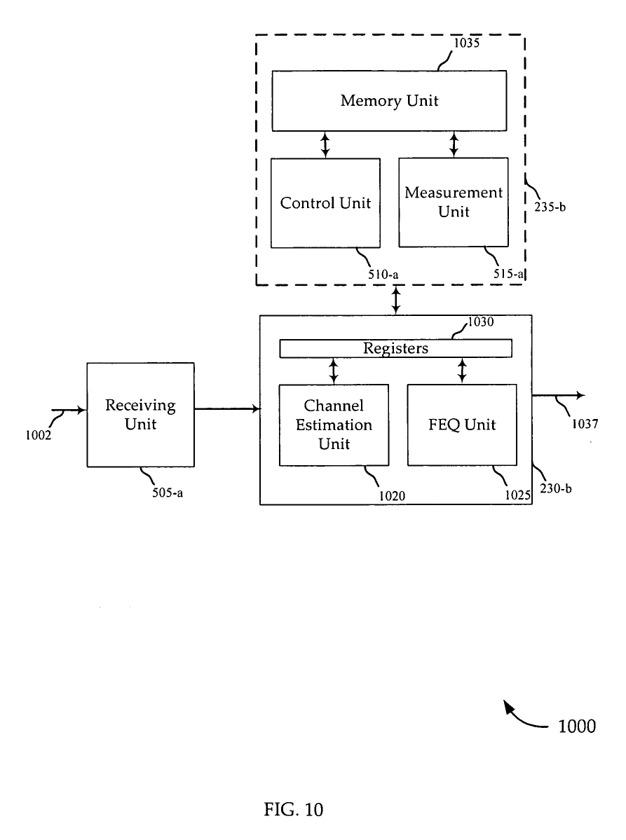

Turning to FIG. 10, a block diagram is shown illustrating an example configuration 1000 of an equalizer unit 230-b and a training timer/acquisition control unit 235-b that may establish initial filter coefficients to acquire a signal for a next burst using filter coefficients from a previous burst, according to various embodiments of the invention. These units 230-b and 235-b of FIG. 10 may be the equalizer unit 230 and a training timer/acquisition control unit 235 of FIG. 2 or 5, implemented in the communications device 105 of FIG. 1. These units 230-b and 235-b of FIG. 10 may have the same functions described with reference to the equalizer unit 230 and the training timer/acquisition control unit 235 of FIG. 2 or 5, in addition to the functions described below. Some or all of the functionality of these units 230-b and 235-b may be implemented in other devices, as well.

The illustrated embodiment includes a receiving unit 505-a, equalizer unit 230-b (including a channel estimation unit 1020, FEQ unit 1025, and registers 1030) and a training timer/acquisition control unit 235-b (including a control unit 510-a, measurement unit 515-a, and memory unit 1035). These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiving unit 505-a may, for example be the RF downconversion and filtering unit 210, FFT unit 225, or input port of the equalizer unit 230 of FIG. 2. Thus, the receiving unit 505-a may be any component configured to receive a wireless signal 1002 with time-multiplexed bursts of data (e.g., the bursts 310 of FIG. 3A). The received signal may be in analog form, or a digitized representation of the signal including a series of real or complex samples.

The equalizer unit 230-b may be configured to reduce power consumption according to a first control signal (e.g., from control unit 510-a), entering a power saving mode between the processing of time-multiplexed bursts of data, and then powering on according to second control signal (e.g., from control unit 510-a) to process the next burst. In various embodiments, there are a number of suspension and activation techniques that may be used to power off or down between bursts. In one embodiment, the decision regarding the use of previous filter coefficients for initial filter coefficients of a next burst is made when the equalizer unit 230-b is suspended. However, in other embodiments the decision regarding initial coefficients is made when the equalizer unit 230-b is still processing a previous burst.

To gain an improved understanding, consider an example of the processing of two successive bursts of received signal. Assume that, in one embodiment, as the first burst is being processed, the channel transfer function is computed by the channel estimation unit 1020 at continual and scattered pilot cells using transmitted and received signals at the continual and scattered pilot cells. The channel estimation unit 1020 may perform time-domain adaptive interpolation to obtain channel transfer function at non-pilot cells of the scattered pilot tones using the channel transfer function computed at continual and scattered pilot cells. The channel estimation unit 1020 may perform frequency-domain adaptive interpolation to obtain channel transfer function at non-pilot cells of non-pilot tones using the channel transfer function computed at continual and scattered pilot cells. As this interpolation occurs, interpolation filter coefficients may be updated. Such updates may be least-mean-square (LMS) or other updates to the time-domain or frequency-domain interpolation coefficients, or other filter coefficients used for interpolation. These updated interpolation filter coefficients may be stored in registers 1030, then used by the FEQ unit 1025 to generate an equalized output signal 1037.

As these interpolation filter coefficients are updated during processing of the first burst, the control unit 510-a may retrieve a subset of the coefficients from the registers 1030, and store them in memory unit 1035. Filter coefficients may be stored from a number of previous bursts, for any number of symbols from one or more of such bursts, or from the last symbol or series of symbols from the registers before the components of the equalizer unit 230-b are suspended between bursts. Thus, the control unit 510-a may send a control signal to suspend one or more of the components of the equalizer unit 230-b when processing for the first burst at the equalizer unit 230-b is completed. When the equalizer unit 230-b is suspended, the data (e.g., including the most recent filter coefficients) stored in the registers 1030 may be lost. The equalizer unit 230-b may remain suspended until the control unit 510-a sends a control signal to activate the equalizer unit 230-b in accordance with its training time allocation.

Upon activation of the equalizer unit 230-b, the registers 1030 therein may not have any information stored on the filter coefficients from the previous burst, as this information may have been lost during the off-time. However, the control unit 510-a may establish one or more of the initial filter coefficients for the equalizer unit 230-b based (in whole or in part) on the stored coefficients retrieved and stored from registers 1030 over one or more previous bursts. This determination may be made while the equalizer unit 230-b is suspended. The control unit 510-a may set the initial coefficients to be the coefficients from the last symbol of the previous burst. Alternatively, the control unit 510-a may set the initial coefficients to be an average set of filter coefficients over a number of symbols of a previous burst, or an average across a number of bursts. Recent bursts, and more recent symbols from a previous burst, may be weighted more heavily. The control unit 510-a may also provide a channel estimation unit 1020 with information on the training symbol structure (e.g., on continual and scattered pilot cells) upon reactivation, as that information may have also been lost from the equalizer unit 230-b when the equalizer unit 230-b was suspended.

As the processing begins for this next burst at the equalizer unit 230-b, channel estimation unit 1020 may perform a series of calculations using the initial filter coefficients. As this interpolation occurs, interpolation filter coefficients are updated. Such updates may be least-mean-square (LMS) or other updates to the initial coefficients (e.g., updating initial time-domain or frequency-domain interpolation coefficients, or other filter coefficients used for interpolation). These updated interpolation filter coefficients may be stored in registers 1030, then used by the FEQ unit 1025 to generate an equalized output signal 1037.

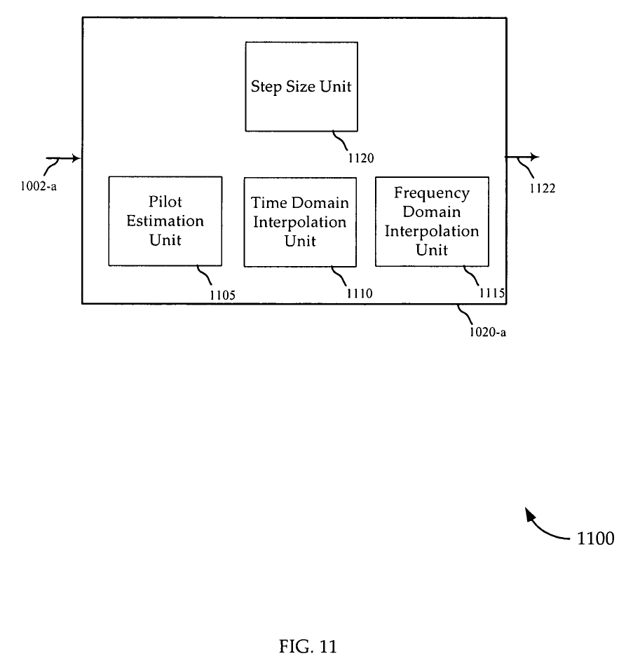

Referring to FIG. 11, a block diagram 1100 is shown illustrating one example of a channel estimation unit 1020-a, which may be the channel estimation unit 1020 described with reference to FIG. 10. In the illustrated embodiment, the a channel estimation unit 1020-a includes a pilot estimation unit 1105, a time domain interpolation unit 1110, a frequency domain interpolation unit 1115, and a step size unit 1120. A digitized version of a received wireless DVB-H signal may be received at the pilot estimation unit 1105, to be acquired in advance of receiving the next burst. The pilot estimation unit 1105 may compute the channel transfer function at continual and scattered pilot cells using transmitted and received signals at the continual and scattered pilot cells.

The time domain interpolation unit 1110 may begin the time-domain adaptive interpolation process by using the initial interpolation filter coefficients to perform interpolation at the continual pilot tones. Estimation errors may be computed by comparing the computed channel transfer function at the pilots to the interpolation results, and the initial filter coefficients may be updated thereby. The updated initial estimates may be used by the time domain interpolation unit 1110 for interpolation at the scattered pilot tones. Thus, the time domain interpolation unit 1110 performs time domain adaptive interpolation to obtain channel transfer function at non-pilot cells of the scattered pilot tones using the channel transfer function computed at continual and scattered pilot cells. The step size unit 1120 may determine the step size used to update the coefficients in the time domain interpolation. There will be additional discussion on step size adjustments below.

After the time domain interpolation, the channel transfer function may be known for the symbols of interest at the continual and scattered pilot tones. The frequency domain interpolation unit 1115 may perform frequency domain adaptive interpolation across subcarriers to estimate the channel transfer function at non-pilot cells of non-pilot tones using the channel transfer function computed at continual and scattered pilot cells with the updated initial filter coefficients. Estimation errors may be computed, and the filter coefficients may be further updated thereby. The step size unit 1120 may determine the step size used to update the coefficients in the frequency domain interpolation, as well. The updated coefficient data may be forwarded 1122 from the channel estimation unit 1020-a (e.g., to the FEQ unit 1025 of FIG. 10).

It is worth noting that in other embodiments, the initial filter coefficients based on coefficients from previous bursts may be used in different ways. For example, the order of processing may change, depending on the patterns of the training symbols and the channel estimation scheme.

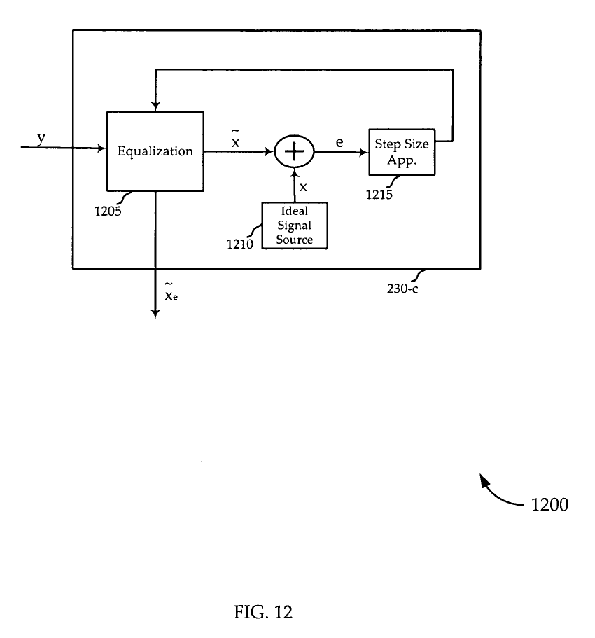

The step size unit 1120, or in some embodiments the control unit 510-a of FIG. 10, may identify different step size values to be used in adaptively changing and updating the filter coefficients. FIG. 12 is a simplified block diagram 1200 illustrating an example of certain functional components within an equalizer unit 230-c, such as the equalizer unit 230 of FIG. 2, 5, or 10. Consider, for example, an input signal y entering the equalizer unit 230-c, in which a low complexity, least-mean-square adaptation algorithm is used. Certain interpolation results \tilde{x} (e.g., calculated using the initial or updated filter coefficients) may be compared to an ideal signal x from an ideal signal source 1210 (which may be calculated, for example, using known pilot tones), and the computed difference may be identified as the error e. The control unit 510-a or step size unit 1120 may control the step size application unit 1215 to have different step sizes μ. In certain embodiments, the step size may be implemented as a gain factor, or scaling factor. Adjustment in step size may impact the rate at which the filter coefficients are adaptively changed, and thus determine the overall time it takes for the coefficients to be updated. The step size factor controls the amount that the error e is applied via a control signal to an input signal y at the equalization unit 1205, to produce \tilde{x}ₑ as the output that may be used for the remainder of the processing.

The step size may be controlled by the control unit 510-a or step size unit 1120 based on a number of factors. For example, when a sufficiently accurate \tilde{x}ₑ is produced within a threshold number of iterations, the step size may be increased. However, if the channel is varying quickly, the step size may be decreased. Thus, the equalizer unit 230-c may adaptively change the initial filter coefficient at a first rate for a first range of channel characteristics, and adaptively change the initial filter coefficient at a second rate for a second range of channel characteristics. Moreover, the rate of adaptive change may differ between the time domain interpolation and frequency domain interpolation (e.g., rates may differ depending on whether Doppler or delay dispersion is the more significant issue). Those skilled in the art will recognize the many variations available. The adaptation may occur one or more times per symbol or, if there are a number of filters, such adaptation may occur for each filter in intermittent symbols. The step size and associated equalization described above may be performed using the equalization processes and devices described in U.S. patent application Ser. No. 11/444,124, filed May 30, 2006, entitled “ADAPTIVE INTERPOLATOR FOR CHANNEL ESTIMATION,” to Long et al.

Returning to the discussion of FIG. 10, the training timer/acquisition control unit 235-b includes a measurement unit 515-a, and its measurements may modify determinations related to the initial filter coefficients and the step size options. The measurement unit 515-a may measure, or receive measurements, on a variety of information. For example, the measurement unit 515-a may retrieve filter coefficients (e.g., initial coefficients or as adapted) from the memory unit 1035, and analyze such coefficients within one, or across a series of, previous burst(s). The measurement unit 515-a may measure the variability of such coefficients (e.g., the rate or amount of change over time). The measurement unit 515-a may measure the training time required for the equalizer unit 230-a on a previous burst, or set of bursts, and also assess the variability thereof. The measurement unit 515-a may measure or receive SNR measurements for a previous burst or series of bursts. The measurement unit 515-a may also estimate, measure, or receive measurements of time between previous bursts, or future bursts. The measurement unit 515-a may measure or receive measurements related to velocity of the device 105 (e.g., for a previous burst, or averaged over a series of bursts), location (e.g., via GPS) of the device 105, or orientation or position of the device. The measurement unit 515-a may store any measurements made or received in the memory unit 1035.

The control unit 510-a may query the memory unit 1035 to access the measurements. The control unit 510-a may then use the measurements to determine whether previous coefficients are to be used (to any extent) instead of, for example, the worst case coefficients. The control unit 510-a may use the measurements to determine whether a step size modification should be made. In addition, the control unit 510-a may use the measurements to identify the initial coefficients and identify step size modifications. Consider, for example, the determination for the particular coefficients to be used as initial filter coefficients. The control unit 510-a may have a set of filter coefficients stored (e.g., in memory unit 1035) for worst case conditions, as well as a set of filter coefficients stored for a previous burst or bursts. The initial filter coefficients may be determined based on a weighted calculation using the set for worst case conditions and the set for a previous burst or bursts. The determinations regarding the initial filter coefficients and step size may be based on the measurements as applied to a series of threshold metrics. These threshold levels, and the actions associated with them, may be set dynamically, or may be pre-set.

The control unit 510-a may use measurements from the immediately preceding burst to make decisions about initial coefficients to be used for a next burst, and for step size modifications. The control unit 510-a may, therefore, make such decisions after the equalizer unit 230-b is suspended after processing the previous burst. These decisions may also be made during or before the previous burst.

By way of example, the control unit 510-a may query the memory unit 1035 to access filter coefficients (e.g., initial coefficient or as adapted) from one, or more, previous bursts. These filter coefficients, and their variability, may be used by the control unit 510-a to establish the initial filter coefficients of a next burst. When a trend of the filter coefficients indicates improving channel characteristics, or indicate stability, the initial filter coefficients may be more weighted to coefficients from one or more previous bursts than to worst case coefficients. However, as filter coefficients indicate worsening channel characteristics, or increasing variability, the initial coefficients as established may be weighted to worst case coefficients. When filter coefficients indicate a worsening channel, the step size may be adjusted downward, so that there are only incremental changes. However, in stable environments, the step size may be increased.

This control unit 510-a may make initial filter coefficient and step size decisions based on any combination of the measurements. For example, when the training time needed to process one or more previous bursts changes, the control unit 510-a may make changes in how initial filter coefficient and step size are determined. The control unit 510-a may also measure the variability of training times over a series of bursts (e.g., including the rate and amount of change), and use this variability measure to make initial filter coefficient and step size decisions. Thus, in stable environments, the initial filter coefficients may be based more heavily on filter coefficients from previous bursts, and step size may be increased.

The control unit 510-a may query the memory to access the measurements on SNR or other signal quality metrics (e.g., relying on a measurement for the previous burst, or an average over a period of time). The control unit 510-a may process the SNR measurement, and the measurement may be used to make initial filter coefficient and step size decisions. By way of example, in one embodiment, initial filter coefficients may be based on previous coefficients only when the SNR exceeds a certain threshold.

The control unit 510-a may query the memory to access the measurements on past or future time between bursts. This information on time between bursts may be used by the control unit 510-a to identify the initial filter coefficients and the step size. As the time between bursts decreases, the initial filter coefficients may be based more heavily on coefficients from previous bursts, and step size may be increased. Also, the measurements may be given different weights as the time between past bursts varies.

The control unit 510-a may query the memory to access the measurements on velocity, location, or orientation of a device 105. The control unit 510-a may process one or more of these measurements to make initial filter coefficient and step size decisions. By way of example, if the measurements indicate that the device is moving (e.g., velocity and orientation change), and is in an urban environment, the control unit 510-a may be configured to use worst case coefficients instead of coefficients computed for previous bursts. A decrease in velocity could trigger the use of filter coefficients computed for previous bursts, and an increase in step size.

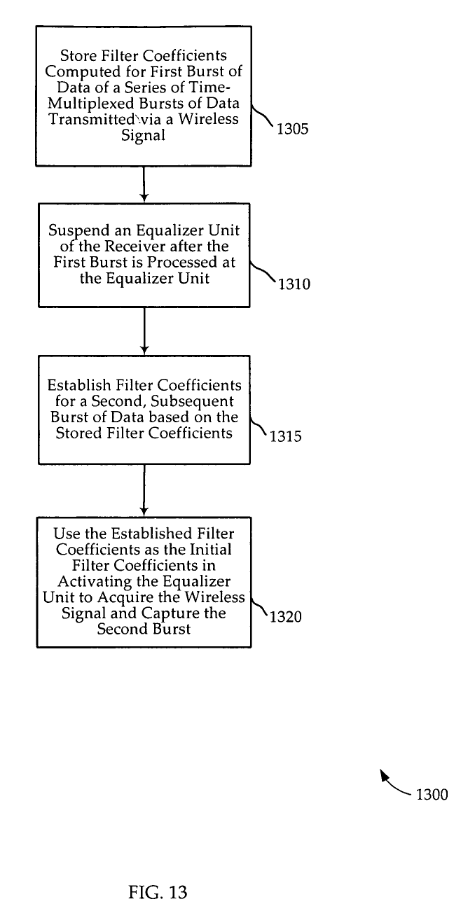

FIG. 13 is a flowchart illustrating a method for establishing filter coefficients for a burst based on filter coefficients from previous bursts according to various embodiments of the invention. The method 1300 may, for example, be performed in whole or in part on the mobile communications device 105 of FIG. 1 or 2 or, more specifically, using a combination of the equalizer unit 230 and training timer/acquisition control unit 235 of FIG. 2, 5, or 10.

At block 1305, filter coefficients are stored, the filter coefficients computed for a first burst of data of a series of time-multiplexed bursts of data transmitted via a wireless signal. At block 1310, an equalizer unit of the receiver is suspended after the first burst is processed at the equalizer unit. At block 1315, filter coefficients are established for a second, subsequent burst of data based on the stored filter coefficients. At block 1320, the established filter coefficients are used as the initial filter coefficients in activating the equalizer unit to acquire the wireless signal and capture the second burst.

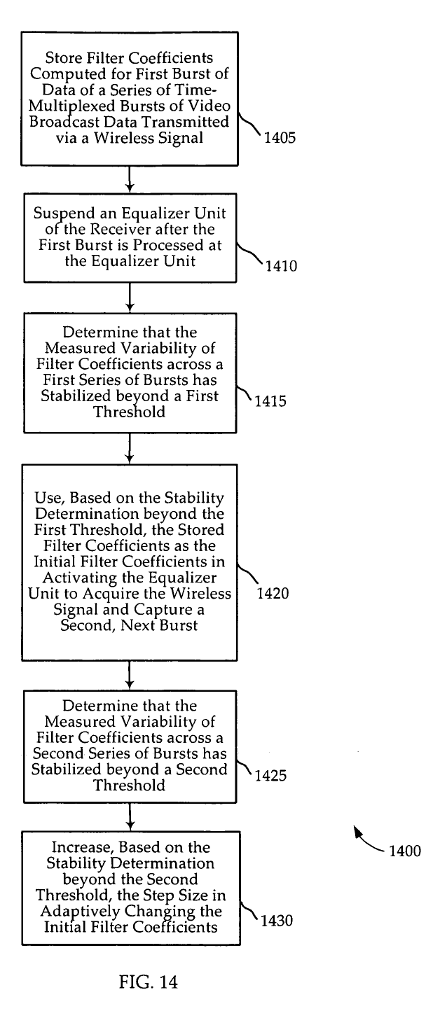

FIG. 14 is a flowchart illustrating a method for using previous filter coefficients and modifying step size according to various embodiments of the invention. As above, the method 1400 may, for example, be performed in whole or in part on the mobile communications device 105 of FIG. 1 or 2 or, more specifically, using a combination of the equalizer unit 230 and training timer/acquisition control unit 235 of FIG. 2, 5, or 10.

At block 1405, filter coefficients are stored, the filter coefficients computed for first burst of data of a series of time-multiplexed bursts of video broadcast data transmitted via a wireless signal. At block 1410, an equalizer unit of the receiver is suspended after the first burst is processed at the equalizer unit. At block 1415, it is determined that the measured variability of filter coefficients across a first series of bursts has stabilized beyond a first threshold. At block 1420, based on the stability determination beyond the first threshold, the stored filter coefficients are used as the initial filter coefficients in activating the equalizer unit to acquire the wireless signal and capture a second, next burst. At block 1425, it is determined that the measured variability of filter coefficients across a second series of bursts has stabilized beyond a second threshold. At block 1430, based on the stability determination beyond the second threshold, the step size used in adaptively changing the initial filter coefficients is increased.

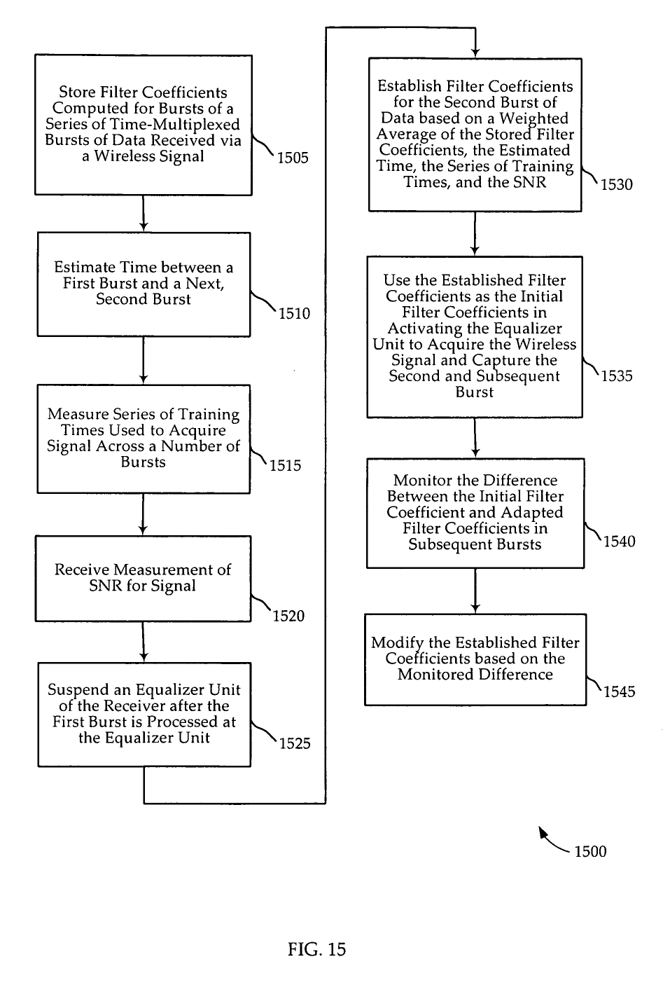

FIG. 15 is a flowchart illustrating a method for establishing filter coefficients for a burst based on filter coefficients from previous bursts and certain measured channel conditions according to various embodiments of the invention. As above, the method 1500 may, for example, be performed in whole or in part on the mobile communications device 105 of FIG. 1 or 2 or, more specifically, using a combination of the equalizer unit 230 and training timer/acquisition control unit 235 of FIG. 2, 5, or 10.

At block 1505, filter coefficients are stored, the filter coefficients computed for bursts of a series of time-multiplexed bursts of data received via a wireless signal. At block 1510, the time between a first burst and a next, second burst is estimated. At block 1515, a series of training times used to acquire the signal across a number of bursts is measured. At block 1520, a measurement of an SNR for the signal is received.

At block 1525, an equalizer unit is suspended after the first burst is processed at the equalizer unit. At block 1530, filter coefficients for the second burst of data are established based on a weighted average of the stored filter coefficients, the estimated time, the series of training times, and the SNR. At block 1535, the established filter coefficients are used as the initial filter coefficients in activating the equalizer unit to acquire the wireless signal and capture the second and subsequent burst.

At block 1540, the difference between the initial filter coefficient and adapted filter coefficients in subsequent bursts is monitored. At block 1545, the established filter coefficients are modified based on the monitored difference.

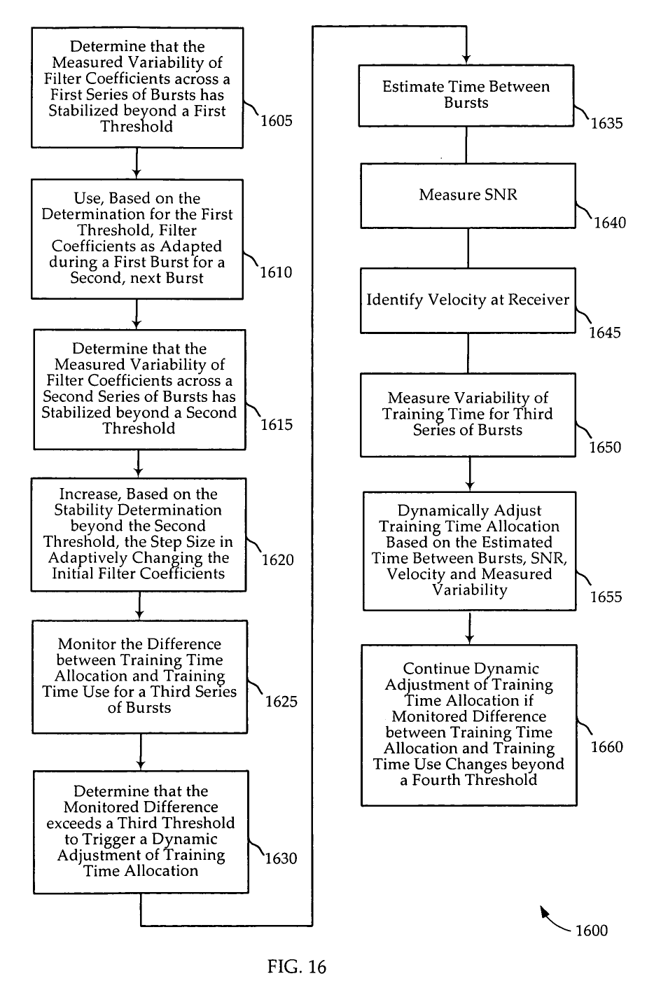

FIG. 16 is a flowchart illustrating a method for using previous filter coefficients, modifying step size, and adjusting training times according to various embodiments of the invention. As above, the method 1600 may, for example, be performed in whole or in part on the mobile communications device 105 of FIG. 1 or 2 or, more specifically, using a combination of the equalizer unit 230 and training timer/acquisition control unit 235 of FIG. 2, 5, or 10.

At block 1605, it is determined that the measured variability of filter coefficients across a first series of bursts has stabilized beyond a first threshold. At block 1610, based on the determination for the first threshold, filter coefficients are used as adapted during a first burst for a second, next burst.

At block 1615, it is determined that the measured variability of filter coefficients across a second series of bursts has stabilized beyond a second threshold. At block 1620, based on the stability determination beyond the second threshold, the step size in adaptively changing the initial filter coefficients is increased.

At block 1625, the difference between the training time allocation and the training time use for a third series of bursts is monitored. At block 1630, it is determined that the monitored difference exceeds a third threshold to trigger a dynamic adjustment of training time allocation. At block 1635, a time between bursts of interest is estimated. At block 1640, the SNR for the wireless signal is measured. At block 1645, the velocity of the receiver is identified. At block 1650, the variability of training time used for a third series of bursts is measured. At block 1655, the training time allocation is dynamically adjusted based on the estimated time between bursts, SNR, velocity, and measured variability. At block 1660, the dynamic adjustment of training time allocation is continued when the monitored difference between training time allocation and training time use changes beyond a fourth threshold.

In one embodiment, the training timer/acquisition control unit 235 of FIG. 2, 5, or 10 may be configured to dynamically adjust the signal acquisition time allocated to RF down-conversion and filtering unit 210, A/D unit 215, CFO correction/symbol synchronization unit 220, FFT unit 225, equalizer unit 230, or FEC decoder unit 240, either individually or collectively. The training timer/acquisition control unit 235 may adjust the time allocated to processing by any of the units specified above during signal acquisition. By reducing the time allocated for processing during signal acquisition in advance of a burst, the components may be turned on for a reduced period of time for signal acquisition. The control unit 510 may reduce the time allocated to one or more of the receiver components 245, for example, based on one or more of the following: SNR, time between bursts, previous acquisition times, variability of previous training times, and any other of the above factors.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flowchart or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, it is worth noting that the RF down-conversion and filtering unit 210, A/D unit 215, CFO correction/symbol synchronization unit 220, FFT unit 225, equalizer unit 230, training timer/acquisition control unit 235, FEC decoder unit 240, or additional layer 2/layer 3 processing unit 250 of FIG. 2, 5, or 10, components thereof, or other embodiments set forth above, may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of establish a filter coefficient for a receiver of a wireless signal, the method comprising:
storing one or more filter coefficients computed for a first burst of data of a plurality of time-multiplexed bursts of data;
transmitting a control signal to suspend an equalizer unit for the receiver after the first burst is processed at the equalizer unit;
establishing a filter coefficient for a second, subsequent burst of data based at least in part on the stored one or more filter coefficients; and
using the established filter coefficient as an initial filter coefficient in activating the equalizer unit to acquire the wireless signal to capture the second burst.

2. The method of claim 1, further comprising:
calculating an estimated time between the first burst and the second burst, the second burst comprising a next burst to be captured after the first burst; and
measuring a series of training times used to acquire the wireless signal across a subset of the plurality of time-multiplexed bursts,
wherein the filter coefficient for the second burst is further established based at least in part on the estimated time and the measured series of training times.

3. The method of claim 1, further comprising:
receiving a measurement of a signal to noise ratio for the wireless signal,
wherein the filter coefficient for the second burst is further established based at least in part on the measured signal to noise ratio.

4. The method of claim 1, further comprising:
monitoring the variability of filter coefficients across bursts of the plurality of time-multiplexed bursts,
wherein the filter coefficient for the second burst is further established based at least in part on the monitored variability, and wherein the establishment of the filter coefficient for the second burst occurs while the equalizer unit is suspended.

5. The method of claim 1, further comprising:
monitoring the variability of filter coefficients across bursts of the plurality of time-multiplexed bursts,
wherein the initial filter coefficient is adaptively changed at a rate based at least in part on the monitored variability.

6. The method of claim 1, further comprising:
adaptively changing the initial filter coefficient at a first rate for a first range of channel characteristics; and
adaptively changing the initial filter coefficient at a second rate for a second range of channel characteristics.

7. The method of claim 6, wherein the channel characteristics comprise a signal to noise ratio, a signal strength measurement, the one or more filter coefficients, a training time allocation, a measure of variability of filter coefficients across the plurality of bursts, or any combination thereof.

8. The method of claim 1, wherein,
the one or more filter coefficients include a first filter coefficient interpolated across symbols at a same subcarrier, and a second filter coefficient is interpolated across subcarriers at a same symbol;
the first filter coefficient and the second filter coefficient each comprise an initial filter coefficient; and
a rate of adaptive change differs for the first filter coefficient differs from the second filter coefficient based on different interpolation types.

9. The method of claim 1, further comprising:
storing one or more additional filter coefficients computed for a subset of the plurality of time-multiplexed bursts of data received before the first burst; and
averaging the stored one or more filter coefficients computed for the first burst with the stored one or more additional filter coefficients to generate a set of average filter coefficients,
wherein the filter coefficient for the second burst is established based at least in part on the set of average filter coefficients.

10. The method of claim 9, wherein,
the stored one or more filter coefficients computed for the first burst of data are weighted more heavily than the stored one or more additional filter coefficients for each burst of the subset in generating the set of average filter coefficients.

11. The method of claim 1, wherein,
the one or more filter coefficients comprise a plurality of complex filter coefficients stored for each of a plurality of subcarriers of an orthogonal frequency division multiplexing (OFDM) signal; and
the initial filter coefficient comprises the stored one or more filter coefficients.

12. A processor for establishing a filter coefficient for a receiver of a wireless signal, the processor comprising:
an input port configured to receive a plurality of samples representative of wireless signal including a plurality of time-multiplexed bursts of data;
an equalizer unit, communicatively coupled with the input port, and configured to:
compute one or more filter coefficients for a first burst of data of the plurality of bursts, the one or more computed filter coefficients stored in a memory unit;
power down and then reactivate between bursts of the plurality of bursts according to a control signal; and
retrieve initial filter coefficients for a second, subsequent burst of data from the memory unit; and
a control unit, communicatively coupled with the equalizer unit, and configured to:
establish initial filter coefficients for a second, subsequent burst of data based at least in part on the one or more computed filter coefficients stored in the memory unit; and
transmit a control signal to reactivate the equalizer unit between the first burst and the second burst.

13. The processor of claim 12, wherein,
the equalizer unit further comprises a plurality of registers, and is further configured to:
transmit the one or more filter coefficients stored in the plurality of registers to the memory unit before powering down after the first burst, the powering down rendering the plurality of registers nonfunctional; and
store the retrieved initial filter coefficients in the plurality of registers after reactivation.

14. The processor of claim 12, wherein,
the control unit is configured to establish the initial filter coefficients after the equalizer unit is powered down after the first burst; and
the second burst is a next burst to be captured after the first burst.

15. The processor of claim 12, wherein the control unit is further configured to establish the initial filter coefficients based at least in part on a measured signal to noise ratio and a measure of variability of filter coefficients across bursts of the plurality of time-multiplexed bursts.

16. The processor of claim 12, wherein,
the one or more filter coefficients comprise the initial filter coefficients; and
the processor further comprises the memory unit.

17. A mobile communications device for establishing a filter coefficient to be used in receiving a wireless signal, the device comprising:
a receiving unit configured to receive the wireless signal including a plurality of time-multiplexed bursts of data;
a memory unit, communicatively coupled with the receiving unit, and configured to:
store one or more filter coefficients for a first burst of data of the plurality of time-multiplexed bursts of data; and
store one or more initial filter coefficients for a second, subsequent burst of data; and
a control unit, communicatively coupled with the memory unit, and configured to:
establish the initial filter coefficient for a second, subsequent burst of data based at least in part on the one or more computed filter coefficients stored in the memory unit; and
transmit a control signal to power down an equalizer unit between the first burst and the second burst.

18. The device of claim 17, further comprising:
a measurement unit, communicatively coupled with the receiving unit and the control unit, and configured to measure a signal to noise ratio for the wireless signal,
wherein the control unit is further configured to establish the filter coefficient for the second burst based at least in part on the measured signal to noise ratio.

19. The device of claim 17, further comprising:
a measurement unit, communicatively coupled with the equalizer unit and the control unit, and configured to measure a series of training times needed to acquire the wireless signal across a subset of the plurality of time-multiplexed bursts,
wherein the control unit is further configured to establish the filter coefficient for the second burst based at least in part on a trend of the measured series of training times.

20. The device of claim 17, further comprising:
a measurement unit, communicatively coupled with the equalizer unit and the control unit, and configured to monitor variability of filter coefficients across bursts of the plurality of time-multiplexed bursts,
wherein the control unit is further configured to establish the filter coefficient for the second burst based at least in part on the variability, the variability comprising both a measure of the range of change and the rate of change.

21. The device of claim 17, further comprising:
a measurement unit, communicatively coupled with the equalizer unit and the control unit, and configured to monitor variability of filter coefficients across bursts of the plurality of time-multiplexed bursts,
wherein the control unit is further configured to:
identify when the variability falls below a threshold; and
increase a rate the initial filter coefficient is adaptively changed based at least in part on the variability falling below the threshold.

22. The device of claim 17, wherein the control unit is further configured to:
receive a signal to noise ratio for the wireless signal;
receive a series of measured training times needed to acquire the wireless signal; and
increase the rate the initial filter coefficient is adaptively changed when the signal to noise ratio exceeds a first threshold or when the length of the series of measured training times falls below a second threshold.

23. A method for establishing a filter coefficient at a receiver, the method comprising:
receiving a wireless signal including a plurality of time-multiplexed bursts of data;
storing one or more filter coefficients computed for a first burst of data of the plurality of bursts;
establishing one or more initial filter coefficients for a second, subsequent burst of data based at least in part on the stored filter coefficients; and
dynamically controlling a rate used in adaptively modifying the one or more initial filter coefficients to acquire the signal.

24. The method of claim 23, wherein the dynamically controlling step comprises:
dynamically controlling the rate used in adaptively modifying the initial filter coefficient based on the variability of monitored filter coefficients across bursts of the plurality of time-multiplexed bursts.

25. The method of claim 23, wherein,
the wireless signal comprises an orthogonal frequency division multiplexing (OFDM) signal comprising a video broadcast, and
the one or more initial filter coefficients comprise complex filter coefficients stored for each of a plurality of subcarriers for the OFDM signal.
